(19) United States
(12) Patent Application Publication
(10) Pub. No.: US 2023/0026109 A1
(43) Pub. Date: Jan. 26, 2023

(54) METHOD FOR PREDICTING AND CALCULATING OF SURFACE ENERGY OF AGGREGATES

(71) Applicant: Wuhan University of Technology, Wuhan (CN)

(72) Inventors: Rong Luo, Wuhan (CN); Longchang Niu, Wuhan (CN); Angang Liu, Wuhan (CN); Xuanjie Chen, Wuhan (CN); Jing Luo, Wuhan (CN); Chongzhi TU, Wuhan (CN); Xiang Wang, Wuhan (CN); Qiang Miao, Wuhan (CN)

(21) Appl. No.: 17/864,139

(22) Filed: Jul. 13, 2022

Related U.S. Application Data
(63) Continuation of application No. PCT/CN2021/120077, filed on Sep. 24, 2021.

(30) Foreign Application Priority Data
Jul. 15, 2021 (CN) 2021108005408

(51) Int. Cl. G01N 13/02

(52) U.S. Cl. CPC G01N 13/02; G01N 2013/0208; G01N 2013/0283

(57) ABSTRACT

A method for predicting and calculating aggregate surface energy is provided and includes steps: (1) raw aggregate screening and treatment; (2) surface texture index acquirement of a polished aggregate and an untreated raw aggregate; (3) powdered aggregate testing by a capillary rise method; (4) polished aggregate testing by a sessile drop method; (5) function relationship formula fitting; and (6) surface energy calculation of raw aggregate. The method not only considers the influence of aggregate's own composition on the surface energy, but also considers the influence of the polishing treatment on the aggregate surface texture, analyzes actual surface texture conditions of the aggregate, and significantly improves the test accuracy by combining the sessile drop method and the capillary rise method. Moreover, it can replace vapor adsorption method to test the surface energy of aggregate, which greatly reduces the test cost and operation difficulty.

### FIELD OF THE DISCLOSURE

The disclosure relates to the field of road engineering, and more particularly to a method for predicting and calculating of surface energy of aggregates.

### BACKGROUND OF THE DISCLOSURE

At present, asphalt pavement has been widely used as the main form of expressway pavement because of its strong adaptability to geological conditions, comfortable driving and convenient maintenance. However, it is found in engineering practice that the asphalt pavement is prone to lose, peeling, cracking and other diseases in the service process, which undoubtedly reduces the driving comfort of the asphalt pavement and increases the maintenance cost. Relevant research shows that this kind of disease is related to the insufficient adhesion between asphalt and aggregate. The adhesion is directly related to the fatigue life, self-healing ability, water stability and other road performance of asphalt mixture. It is precisely because of the compatibility between different asphalts and aggregates that the adhesion between different asphalts and aggregates is different.

In order to reduce pavement diseases and select the appropriate combination of asphalt and aggregate, the adhesion between asphalt and aggregate needs to be evaluated. The surface energy theory commonly used in the world can accurately and quantitatively evaluate the adhesion between asphalt and aggregate from the micro perspective of intermolecular force, and can be applied to the evaluation of pavement performance of asphalt mixture. The surface energy of asphalt and aggregate is measured through the test, and the cohesion binding energy and adhesion binding energy are calculated by using the surface energy theory to evaluate the performance of asphalt mixture, and further calculate the asphalt aggregate matching index, so as to provide a reasonable and effective reference basis for selecting the asphalt aggregate combination with good compatibility.

Before evaluating the pavement performance of asphalt mixture, it is necessary to measure the surface energy of asphalt and aggregate respectively. For aggregates, the vapor adsorption method is a more accurate test method. The test results of the vapor adsorption method are accurate and highly automated, but there are strict requirements on the particle size of aggregates, and the price of instruments is very expensive, which makes the requirements of test conditions high, test resources scarce and consumes a lot of engineering costs. In contrast, the sessile drop method and capillary rise method are two kinds of aggregate surface energy test methods. The test principle is simple, the test instrument is more conventional, and the test operation is simple and easy.

Relevant research shows that the chemical composition and surface texture characteristics of aggregate will affect the surface energy of aggregate, and then affect the adhesion between asphalt and aggregate. The vapor adsorption method can not only characterize the component properties of the material itself, but also does not change its original surface texture, but the test cost is high. In contrast, the sessile drop method can quantify the effect of surface texture on aggregate surface energy, but it is difficult to characterize the effect of aggregate composition on aggregate surface energy. The test can only be carried out when the aggregate is ground into powder by the capillary rise method, focusing on the composition of the aggregate, but ignoring the influence of surface texture on the surface energy of the aggregate. In order to choose a simpler and lower cost test method to replace the expensive vapor adsorption test equipment, and take into account the two influencing factors of aggregate composition and surface texture, it is necessary to propose a new aggregate surface energy prediction method.

### SUMMARY OF THE DISCLOSURE

The purpose of the disclosure is to provide a method for predicting and calculating surface energy of aggregate (also referred to as a prediction and calculation method of surface energy of aggregate), which is used to solve the problem that the traditional vapor adsorption method is expensive, and the traditional sessile drop method (also referred to as static drop method) and capillary rise method are difficult to take into account the two influencing factors of aggregate composition and surface texture.

In order to solve the above technical problems, the disclosure provides a method for predicting and calculating surface energy of aggregate, including:

step (1), raw aggregate screening and treatment, including: screening a raw aggregate and dividing the screened raw aggregate into a polished aggregate been sequentially surface polished and pretreated, an untreated raw aggregate, and a powdered aggregate been ground in form of powder;

step (2), surface texture index acquirement of the polished aggregate and the untreated raw aggregate, including: measuring surface textures of the untreated raw aggregate and the polished aggregate to obtain a surface texture index of the untreated raw aggregate and a surface texture index of the polished aggregate respectively;

step (3), powdered aggregate testing by a capillary rise method, including: testing the powdered aggregate by the capillary rise method to obtain surface energy of the powdered aggregate without influence of surface texture;

step (4), polished aggregate testing by a sessile drop method, including: testing a contact angle of the polished aggregate by the sessile drop method, and calculating surface energy of the polished aggregate;

step (5), function relationship formula fitting, including: fitting based on the surface texture index of the polished aggregate, the surface energy of the powdered aggregate and the surface energy of the polished aggregate to obtain a function relationship formula of surface texture index and surface energy; and

step (6), surface energy calculation of raw aggregate, including: substituting the surface texture index of the untreated raw aggregate into the function relationship formula of surface texture index and surface energy to thereby obtain surface energy of the raw aggregate considering influence of surface texture.

In an embodiment, each of the untreated raw aggregate and the polished aggregate includes aggregate samples with a particle size of 13.2˜16 mm after the screening. The polished aggregate has been surface polished by one or more selected from a group consisting of three surface polishing methods of cutting saw polishing, grinding wheel polishing and sandpaper polishing, a polishing time of each of the surface polishing methods is more than 30 seconds; and for each of the surface polishing methods, polishing degrees of the aggregate samples of the polished aggregate are the same.

In an embodiment, a preparation of the powdered aggregate includes: weighing the screened raw aggregate with a particle size in a range of 2.36˜4.75 mm and then grinding the weighed raw aggregate, sieving the ground raw aggregate to obtain powders with particle sizes less than 0.075 mm to thereby obtain the powdered aggregate.

In an embodiment, the measuring surface textures of the untreated raw aggregate and the polished aggregate to obtain a surface texture index of the untreated raw aggregate and a surface texture index of the polished aggregate respectively includes: fixing the aggregate samples of the untreated raw aggregate on an aggregate tray, collecting surface texture images of the aggregate samples of the untreated raw aggregate with an instrument of aggregate image measurement system (AIMS), and calculating the surface texture index of the untreated raw aggregate after averaging collection results; and fixing the aggregate samples of the polished aggregate on the aggregate tray, collecting surface texture images of polished surfaces of the aggregate samples of each of the surface polishing methods with the instrument of AIMS, and calculating the surface texture index of the polished aggregate of each of the surface polishing methods after averaging collection results.

In an embodiment, the testing the powdered aggregate by the capillary rise method includes: saturating and curing the powdered aggregate with toluene, and calculating effective radii of capillary synthesis through the capillary rise method with 2-pentanone, formamide and n-hexane as first test reagents; testing by using a surface tension instrument under the first test reagents individually based on the capillary rise method, calculating a diffusion pressure under each of the first test reagents combined with the effective radius of capillary synthesis, and then calculating the surface energy of the powdered aggregate without the influence of surface texture according to Young-Dupre equation.

In an embodiment, a calculation formula of the diffusion pressure is:

$${π}_{e ( M L )} = \frac{2 η}{{π}^{2} {R}_{e}^{5} {ρ}_{L}^{2}} \cdot \frac{{m}^{2}}{t} ;$$

where π_{e(ML)} represents the diffusion pressure, m represents a mass variation of the powdered aggregate, t represents time, ρL represents a density of the test reagent, Rₑ represents the effective radius of capillary synthesis, and η represents a diffusion pressure coefficient.

In an embodiment, the testing a contact angle of the polished aggregate by using the sessile drop method includes: starting an optical contact angle measuring instrument and preheating, placing the polished aggregate in a test chamber of the optical contact angle measuring instrument, and making the polishing surface of each of the aggregate samples of the polished aggregate be horizontal and face towards a camera of the optical contact angle measuring instrument; adjusting reagent needles to preset positions, and releasing droplets of different second test reagents respectively; moving the test chamber to make each of the aggregate samples correspondingly receive the released droplet; and testing the contact angle between each of the aggregate samples and a received droplets within a preset test time.

In an embodiment, the adjusting reagent needles to preset positions specifically includes: pumping the different second test reagents into syringes respectively, moving positions of the reagent needles until a distance between each of the reagent needles and corresponding one of the aggregate samples is one droplet, and making the reagent needles and the aggregate samples appear in a capture image of the camera. The releasing droplets of different second test reagents respectively includes: controlling pressures of the respective syringes to release the droplets with a same volume of the different second test reagents, and each of the released droplets is attached to a tip of each of the reagent needles. The different second test reagents include distilled water, formamide and ethylene glycol, the different second test reagents are pumped with three different syringes respectively, and each of the reagent needles releases the droplet of one of the different second test reagents correspondingly.

In an embodiment, the calculating surface energy of the polished aggregate specifically includes: substituting the contact angle between the polished aggregate and each of the different second test reagents into the Young-Dupre equation, obtaining surface energy parameters by programming solution, and calculating the surface energy of the polished aggregate been treated by each of the surface polishing methods according to the surface energy parameters. A calculation formula of the surface energy of the polished aggregate is:

2(\sqrt{γ_{S}^{LW}γ_{L}^{LW}}+\sqrt{γ_{S}⁺γ_{L}⁻}+\sqrt{γ_{S}⁻γ_{L}⁺})=γ_{L}(1+cos θ);

in the formula, the surface energy parameters include γ_{S}^{LW}, γ_{L}^{W}, γ_{L}^{LW}, γ_{S}⁺, γ_{S}⁻, γ_{L}⁺, γ_{L}⁻ and γ_{S}^{LW}, where γ_{S}^{LW} represents a non-polar component of surface energy of solid material, γ_{L}^{LW} represents a non-polar component of surface energy of liquid material, γ_{S}⁺ represents a polar acid component of the surface energy of solid material, γ_{S}⁻ represents a polar alkali component of the surface energy of solid material, γ_{L}⁺ represents a polar acid component of the surface energy of liquid material, γ_{L}⁻ represents a polar alkali component of the surface energy of liquid material, γ_{L} represents a liquid surface tension as a total surface energy, in unit of erg per square centimeter (erg/cm²), and θ represents the contact angle between three phases of solid, liquid and gas.

In an embodiment, the fitting based on the surface texture index of the polished aggregate, the surface energy of the powdered aggregate and the surface energy of the polished aggregate to obtain a function relationship formula of surface texture index and surface energy specifically includes: performing exponential fitting on the surface energy of the polished aggregate and the surface texture of the polished aggregate to obtain the function relationship formula of surface texture index and surface energy, and the function relationship formula is specifically as follows:

γ=Ae^{Kx};

where γ is an aggregate surface energy considering the influence of surface texture, in unit of erg/cm²; x is a surface texture index of aggregate; A is the surface energy of the powdered aggregate without the influence of surface texture, in unit of erg/cm²; K is a constant of determining an influence degree of surface texture on surface energy. In the exponential fitting, the parameters A and K are obtained, and the function relationship formula of surface texture index and surface energy is determined. The surface texture index of the raw aggregate is substituted into the function relationship formula of surface texture index and surface energy to obtain the surface energy of the raw aggregate considering the influencing of surface texture.

Compared with the related art, the embodiments of the disclosure may mainly have the following beneficial effects.

The disclosure provides a method for predicting and calculating surface energy of aggregate. In the process of calculating surface energy of aggregate, the method considers not only the influence of aggregate composition on surface energy, but also the influence of polishing treatment on aggregate surface texture, and analyzes the actual surface texture conditions of aggregate. The combination of the sessile drop method and the capillary rise method significantly improves the test accuracy, and can replace the vapor adsorption method to test the surface energy of aggregate, which greatly reduces the test cost and operation difficulty.

### BRIEF DESCRIPTION OF DRAWINGS

FIG. 1 is a schematic flowchart of a method for predicting and calculating surface energy of an aggregate of an embodiment of the disclosure.

FIG. 2 is a schematic diagram of capillary rise method of the method for predicting and calculating surface energy of an aggregate of the embodiment of the disclosure.

FIG. 3 is an image showing a full-automatic surface tension instrument of the method for predicting and calculating surface energy of an aggregate of the embodiment of the disclosure.

FIG. 4 is an image showing an optical contact angle measuring instrument of the method for predicting and calculating surface energy of an aggregate of the embodiment of the disclosure.

FIG. 5 shows fitting curves and function relationship formulas between surface texture indexes and surface energies of two kinds of aggregates in embodiment 1 of the disclosure.

### DETAILED DESCRIPTION OF EMBODIMENTS

The technical solutions in the embodiments of the disclosure will be clearly and completely described below in combination with the embodiments of the disclosure. Obviously, the described embodiments are only some of the embodiments of the disclosure, not all of them. Based on the embodiments of the disclosure, all other embodiments obtained by those skilled in the art without creative work belong to the protection scope of the disclosure.

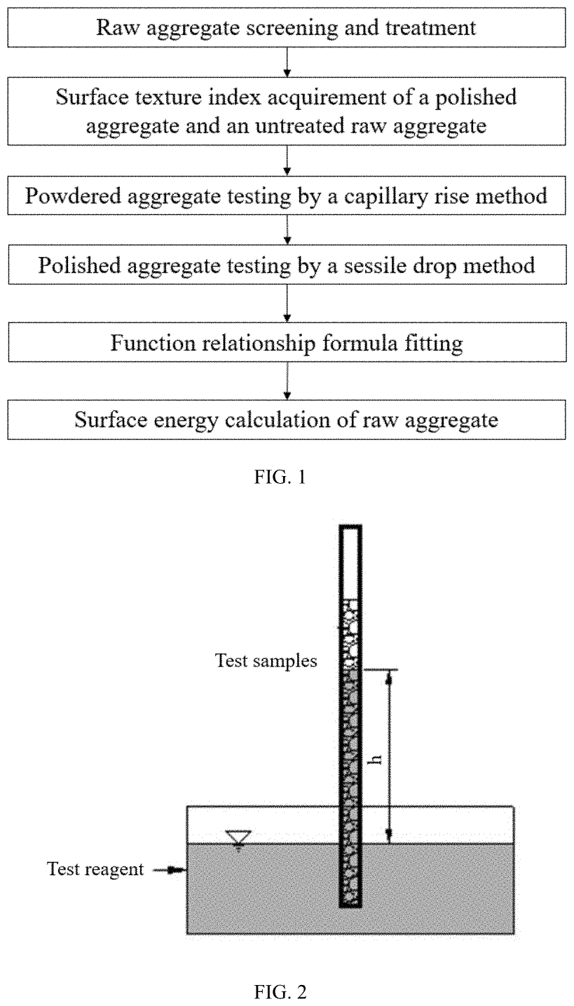

Referring to FIG. 1, FIG. 1 is a schematic flowchart of a method for predicting and calculating surface energy of aggregate of an embodiment in the disclosure. The method for predicting and calculating surface energy of aggregate in the disclosure includes steps as follows.

Step (1), raw aggregate screening and treatment (e.g., polishing, grinding). In this step, after screening, the raw aggregate is divided into a polished aggregate been sequentially surface polished and pretreated, an untreated raw aggregate, and a powdered aggregate been ground in form of powder. Each of the raw aggregate and the polished aggregate includes aggregate samples with a particle size of 13.2˜16 millimeters (mm) after the screening. The polished aggregate has been surface polished by one or more selected from a group consisting of three surface polishing methods of cutting saw polishing, grinding wheel polishing and sandpaper polishing, a polishing time of each of the surface polishing methods is more than 30 seconds; and for each of the surface polishing methods, polishing degrees of the aggregate samples of the polished aggregate are the same. However, due to the difference of grinding tools, the polished aggregate presents three surfaces with different roughness, which led to subsequent discrepancies in the surface texture index data for the polished aggregates. In the illustrated embodiment, a preparation of the powdered aggregate are as follows. The screened raw aggregate with a particle size in a range of 2.36˜4.75 mm is weighed and ground, and powders with particle sizes less than 0.075 mm after sieving are obtained, which is the powdered aggregate. Since the powdered aggregate is a grinding treatment of the raw aggregate, the influence of surface texture on the surface energy of aggregate can be ignored, and the surface texture of aggregate can be regarded as 0. In addition, after the surface of the polished aggregate is polished, it can also be rinsed with distilled water until there is no sediment attached to the surface, and the cleaned aggregate samples can be dried at a temperature in a range of 110˜120° C. to ensure that the particle surfaces of the polished aggregate samples are clean, which is conducive to the subsequent surface texture data collection.

Step (2), surface texture index acquirement. In this step, a surface texture index of the raw aggregate and a surface texture index of the polished aggregate need to be obtained. On the one hand, the aggregate samples of the untreated raw aggregate are fixed on an aggregate tray, the surface texture data of the raw aggregate samples is collected, and the surface texture index of the untreated raw aggregate after averaging the collection results is calculated. On the other hand, the aggregate samples of the polished aggregate are fixed on the aggregate tray, the surface texture data of the polished surface of the aggregate sample of each of the surface polishing methods is collected, and the surface texture index of the polished aggregate of each of the surface polishing methods after averaging the collection results is calculated. In the illustrated embodiment, viscous materials such as plasticine are used to fix the aggregate samples to ensure the stability of the aggregate samples during data collection. The image data of surface texture is collected by an instrument of aggregate image measurement system (AIMS), the surface texture indexes of the aggregate samples under the same surface polishing method obtained by AIMS are averaged and the surface texture indexes of the aggregate samples in the untreated raw aggregate are averaged, thereby obtaining the surface texture indexes of the polished aggregate under the three methods of the cutting saw polishing, the grinding wheel polishing and the sandpaper polishing, and the surface texture index of the raw aggregate. Moreover, the surface texture indexes of the polished aggregate under the three surface polishing methods respectively represent the surface texture states of aggregate under different roughness, while the surface texture index of the untreated raw aggregate represents the surface texture state of aggregate under an original roughness.

Step (3), powdered aggregate testing by a capillary rise method. Referring to FIG. 2, in this step, the capillary rise test is carried out on the powdered aggregate, and the surface energy of the powdered aggregate without the influence of surface texture is obtained. The specific steps include step i and step ii as follows.

Step i, saturating and curing the powdered aggregate with toluene, and calculating effective radii of capillary synthesis through the capillary rise method with 2-pentanone, formamide and n-hexane as first test reagents.

In the illustrated embodiment, firstly, the powdered aggregate samples are saturated with toluene for curing, the powdered aggregate is placed into a clean sealed bottle containing toluene, a curing time is half a month, and the sample quality is measured every 24 hours until the quality does not change, so as to ensure that the toluene on the surface of the powdered aggregate is saturated. The reason why toluene is selected is that toluene has good volatility and is easy to be adsorbed on the surface of the test sample.

Then, the powdered aggregate after toluene vapor saturation curing is filled into a metal cylinder. In order to ensure the repeatability of the test results, the compactness of each test sample should be the same. Moreover, before filling the test sample, a piece of filter paper is placed under the metal cylinder to prevent the test sample from leaking out. After each test, the metal cylinder is cleaned with distilled water, and then the metal cylinder is placed into the oven for heating and drying, the oven temperature is set at 100° C. and the drying time is set at least 15 minutes to maintain the cleanliness of the metal cylinder before each test, so as to obtain more accurate test results.

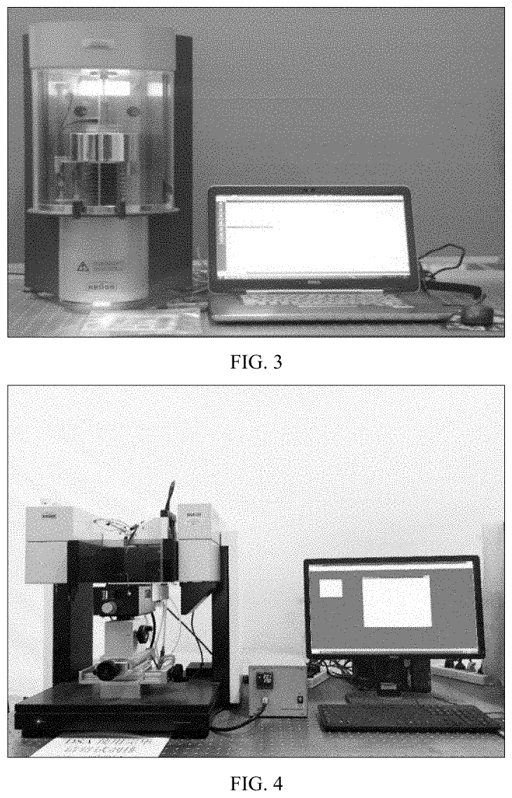

Finally, the capillary rise test is carried out with a full-automatic surface tension instrument. Referring to FIG. 3, the test is carried out with three first reagents: 2-pentanone, formamide and n-hexane. Each of the first test reagents is tested three times. The specific steps are as follows. The first test reagent with the temperature of 20° C. is first placed on an instrument sample table, and then the metal cylinder filled with powdered aggregate is fixed on a fixture. A control button is pressed to slowly raise the sample table loaded with the first test reagent until the surface of first test reagent is as close as possible to the bottom of metal cylinder, but ensure that the surface of first test reagent is not in direct contact with metal cylinder, once contact is made, the sample must be refilled. After fixing the metal cylinder, the test parameters are set and the test is started. The sample table is lifted by the instrument at the set speed until the bottom end of the cylinder reaches the set immersion depth of 1 mm, and then the change of sample quality after the first test reagent is immersed in the test sample is weighed by the balance at the top of the instrument. The absorption amount in of the test sample to the first test reagent obtained at different times t is recorded by the instrument. When it is observed that the absorption amount of the test sample tends to be flat with time, it indicates that the first test reagent has risen to the top of the cylinder. At this time, all samples in the metal cylinder have been wetted, and the test can be stopped directly. In this process, the capillary rise test of toluene is carried out on the powdered aggregate after saturation curing of toluene, and a ratio m²/t of toluene after saturation curing of the powdered aggregate is obtained. The capillary synthesis effective radius Rₑ of the powdered aggregate can be calculated by using the following formula (1).

$${R}_{e} = \sqrt[5]{\frac{2 η}{{π}^{2} {ρ}_{L}^{2} {γ}_{L}} \cdot \frac{{m}^{2}}{t}} \qquad ( 1 )$$

In the formula (1), γ_{L} represents a liquid surface tension, m represents a mass variation of the powdered aggregate, t represents time, ρL represents a density of first test reagent, Rₑ represents the effective radius of capillary synthesis, and η represents a surface tension coefficient.

Step ii, testing by using a surface tension instrument under the first test reagents individually based on the capillary rise method, calculating a diffusion pressure under each of the first test reagents combined with the effective radius of capillary synthesis, and then calculating the surface energy of the powdered aggregate without the influence of surface texture according to Young-Dupre equation.

In the illustrated embodiment, the powdered aggregate is placed into a clean sealed bottle containing phosphorus pentoxide, dried for 24 hours, and then the capillary rise test is carried out with the full-automatic surface tension instrument. Three chemical reagents, n-hexane, 2-pentanone and formamide, were used to test successively, and each reagent was tested three times. The ratio m²/t is calculated by linear fitting to ensure that the coefficient of variation of the test results is less than 10%, and results of m²/t of chemical component samples tested with three reagents under completely dry conditions are obtained. Combined with the effective radii of capillary synthesis of the powdered aggregate obtained above, the diffusion pressures of the test samples to n-hexane, 2-pentanone and formamide can be calculated respectively by using the following formula (2).

$${π}_{e ( M L )} = \frac{2 η}{{π}^{2} {R}_{e}^{5} {ρ}_{L}^{2}} \cdot \frac{{m}^{2}}{t} \qquad ( 2 )$$

In the formula (2), π_{e(ML)} represents the diffusion pressure, m represents the mass variation of the powdered aggregate, t represents time, ρL represents the density of test reagent, Rₑ represents the effective radius of capillary synthesis, and η represents the diffusion pressure coefficient. Finally, the diffusion pressure values of the test samples for n-hexane, 2-pentanone and formamide are substituted into the following formula (3) to solve the simultaneous equations to thereby obtain the surface energy of the 9 groups of the powder aggregates, and the obtained surface energy of the powdered aggregates are the raw aggregate surface energy under the condition that the surface texture is 0.

$$( \begin{matrix}\frac{{π}_{e ( M L ) 1}}{2} + {γ}_{L 1} \\ \frac{{π}_{e ( ML ) 2}}{2} + {γ}_{L 2} \\ ⋮ \\ \frac{{π}_{e ( ML ) n}}{2} + {γ}_{L n}\end{matrix} ) = [ \begin{matrix}\sqrt{{γ}_{L 1}^{L W}} & \sqrt{{γ}_{L 1}^{-}} & \sqrt{{γ}_{L 1}^{+}} \\ \begin{matrix}\sqrt{{γ}_{L 2}^{L W}} \\ ⋮\end{matrix} & \begin{matrix}\sqrt{{γ}_{L 2}^{-}} \\ ⋮\end{matrix} & \begin{matrix}\sqrt{{γ}_{L 2}^{+}} \\ ⋮\end{matrix} \\ \sqrt{{γ}_{L n}^{L W}} & \sqrt{{γ}_{L n}^{-}} & \sqrt{{γ}_{L n}^{+}}\end{matrix} ] [ \begin{matrix}\sqrt{{γ}_{M}^{L W}} \\ \sqrt{{γ}_{M}^{+}} \\ \sqrt{{γ}_{M}^{-}}\end{matrix} ] \qquad ( 3 )$$

In the formula (3), n represents the number of selected test reagents, and n≤3, π_{e(ML)n} is represents a diffusion pressure of a n-th reagent, γ_{Ln}⁺, γ_{Ln}⁻, γ_{Ln}^{LW} and γ_{Ln} respectively represent a polar acid component of surface energy, a polar alkali component of surface energy, a non-polar component of surface energy and a total surface energy of the n-th chemical reagent respectively, and γ_{M}^{LW}, γ_{M}⁺, and γ_{M}⁻ are a non-polar component, a polar acid component and a polar alkali component of surface energy of the powdered aggregate respectively.

Step (4), polished aggregate testing by a sessile drop method. In this step, a contact angle of the polished aggregate is tested firstly by using the sessile drop method. The specific steps include step a through step d as follows.

Step a, 30 minutes before the test, an optical contact angle measuring instrument, a supporting thermostatic water bath system and a micro compressor are started for preheating, so that the temperature inside the test chamber of the optical contact angle measuring instrument is stabilized at about 20° C. In the illustrated embodiment, DSA100 optical contact angle measuring instrument as shown in FIG. 4 is adopted. The polished aggregate is evenly fixed in the test chamber by using viscous materials such as plasticine to fix the non-polishing surface of the polished aggregate, so that the polishing surface is placed horizontally upward, and the polishing surface of each aggregate sample in the polished aggregate face towards the camera of the optical contact angle measuring instrument.

Step b, reagent needles are adjusted to preset positions, the test reagents are respectively pumped into the syringes, positions of the reagent needles are moved until a distance between each of the reagent needles and corresponding one of the aggregate samples is one droplet, and the reagent needles and the aggregate samples appear in a capture image of the camera. The pressures of the respective syringes are controlled, the software is operated to release 1.0 microliter (μL) droplets of the same volume from different second test reagents, and each of the released droplets are attached to the tip of the needles. In this embodiment, distilled water, formamide and ethylene glycol are selected as second test reagents, so that the test reagent contains both polar solvent and non-polar solvent, and each needle releases the droplet of one of the different second test reagents correspondingly.

Step c, the test chamber is moved to make each of the aggregate samples correspondingly receive the released droplet.

Step d, the contact angle between each of the aggregate samples and the received droplet is tested within a preset test time. On the surface of each of the aggregate samples, the intersection of the received droplet and its projection is set as the baseline, and the included angle between the tangent and the baseline at the intersection of the droplet contour is measured by the optical contact angle instrument, which is recorded as the contact angle. The contact angles between the polished aggregate and different test reagents are obtained by image capture software. Among them, the preset test time is different for different test reagents. When distilled water is used as the test reagent, the preset test time of contact angle is 10˜30 seconds. When formamide or ethylene glycol is used as the second test reagent, the preset test time of contact angle is greater than 20 seconds.

Then, the surface energy of the polished aggregate is calculated according to the contact angle of the polished aggregate. The specific calculation steps are as follows: the contact angle between the polished aggregate and each of different second test reagents is substituted into the Young-Dupre equation, surface energy parameters are obtained by using Excel to perform programming solution, and the surface energy of the polished aggregate treated by different surface polishing methods is calculated according to the surface energy parameters. The calculation formula of surface energy of polished aggregate is as follows.

2(\sqrt{γ_{S}^{LW}γ_{L}^{LW}}+\sqrt{γ_{S}⁺γ_{L}⁻}+\sqrt{γ_{S}⁻γ_{L}⁺})=γ_{L}(1+cos θ) (4)

In the formula (4), the surface energy parameters include γ_{S}^{LW}, γ_{L}^{LW}, γ_{S}⁺, γ_{S}⁻, γ_{L}⁺, γ_{L}⁻ and γ_{L}, where γ_{S}^{LW} represents a non-polar component of surface energy of solid material, γ_{L}^{LW} represents a non-polar component of surface energy of liquid material, γ_{S}⁺ represents a polar acid component of the surface energy of solid material, γ_{S}⁻ represents a polar alkali component of the surface energy of solid material, γ_{L}⁺ represents a polar acid component of the surface energy of liquid material, γ_{L}⁻ represents a polar alkali component of the surface energy of liquid material, γ_{L} represents a liquid surface tension as a total surface energy, in unit of erg per square centimeter (erg/cm²), and θ represents the contact angle between three phases of solid, liquid and gas.

Step (5), function relationship formula fitting. In this step, based on the surface texture index of polished aggregate, the surface energy of the powdered aggregate and the surface energy of the polished aggregate, the function relationship formula of surface texture index and surface energy is obtained. The specific function relationship formula is as follows:

γ=Ae^{Kx} (5)

In the formula (5), γ is an aggregate surface energy considering the influence of surface texture, in unit of erg/cm²; x is a surface texture index of aggregate; A is the surface energy corresponding to the aggregate surface texture index in a state of x=0, which is also the surface energy of the powdered aggregate without the influence of surface texture factors, in unit of erg/cm²; K is a constant of determining an influence degree of surface texture on the surface energy. In the process of exponential fitting, the parameters A and K are obtained, and the function relationship formula of surface texture index and surface energy is determined.

Step (6), surface energy calculation of raw aggregate. In this step, the surface texture index of the raw aggregate in the step (2) is substituted into the function relationship formula of surface texture index and surface energy in the step (5), and the surface energy of the raw aggregate considering the influence of the surface texture factor is obtained.

The effectiveness of the application of the above method for predicting and calculating the surface energy of aggregates is described below by means of a specific embodiment.

### Embodiment 1

S1, selecting two kinds of aggregates for screening, polishing and grinding.

Specifically, the test materials selected in this embodiment include diabase and basalt. The two kinds of aggregates are screened to obtain aggregate samples with a particle size in a range of 13.2˜16 mm, and each aggregate is 80 particles. In each kind of aggregate, 20 particles are not treated as the untreated raw aggregate, and the other 60 particles are used as polished aggregate. The 60 particles of aggregate samples are polished by three surface polishing methods including cutting saw polishing, grinding wheel polishing and sandpaper polishing, in which 20 particles of aggregate samples are polished by each of the surface polishing methods as parallel tests, and processing time is more than 30 seconds. The two kinds of aggregate samples after polishing are classified according to different surface polishing methods, and are rinsed continuously with distilled water until there is no sediment attached on the surface, and the rinsed water is clear and free of impurities. The cleaned polished aggregate is placed in a 120° C. oven for 4 hours, and the water is dried for later use.

Moreover, the two kinds of aggregate samples are weighed about 50 grains (g) of aggregates with a particle size in a range of 2.36˜4.75 mm and placed into a cylinder, and a vibration time of an instrument is set to 50 seconds. The vibration mill is turned on to make the cylinder vibrate at high speed driven by an eccentric block, which drives the aggregate samples in the cylinder to turn over quickly, and collides with the cylinder at a high speed at the same time. Under regular high-speed collisions, the aggregate samples are quickly ground, the ground powder are sieved, powdered aggregate samples with particle sizes of less than 0.075 mm are selected as a powdered aggregate, and the powdered samples are placed into a drying oven for later use.

S2, obtaining surface texture indexes of the two kinds of aggregates.

Specifically, a 12.5 mm aggregate tray is selected, the 20 particles of aggregate samples processed by polishing each kind of aggregate are placed in a groove of the aggregate tray, and the aggregate samples are fixed with plasticine so that the polished side is horizontal and upward. The aggregate tray with the fixed aggregate samples is put into the AIMS instrument to ensure that the camera can align with the polishing surface. The surface texture indexes of aggregate samples for each kind of aggregate are measured and an average value is taken to obtain the surface texture indexes of the polished aggregate under the three methods of cutting saw polishing, grinding wheel polishing and sandpaper polishing, and the surface texture index of the raw aggregate.

S3, testing the powdered aggregate by using capillary rise method.

Specifically, the obtained powdered aggregate is performed operation steps of the above capillary rise test by using toluene, 2-pentanone, formamide and n-hexane as test reagents, and the surface energy of the powdered aggregate without the influence of surface texture factor is calculated. The specific operation steps are not described here.

S4, calculating surface energy of the two kinds of aggregates based on sessile drop method.

For the two kinds of aggregates treated by different surface polishing methods, contact angles with distilled water, formamide and ethylene glycol are tested by the above sessile drop method, and each test reagent is released 1 μL. Five parallel tests are carried out for each kind of aggregate using one of the different surface polishing methods of aggregate samples, and the average value is taken as a result of the contact angle. Then, the contact angles measured between the aggregate samples with the same surface polishing method and the three reagents of each kind of aggregate is substituted into the Young-Dupre equation shown in the formula (4) to calculate the surface energy. In this way, the surface energy of each of two kinds of aggregates with three surface polishing methods can be obtained.

S5, fitting to obtain a function relationship formula of surface texture index and surface energy, and calculating the surface energy of the raw aggregates of each of the two aggregates.

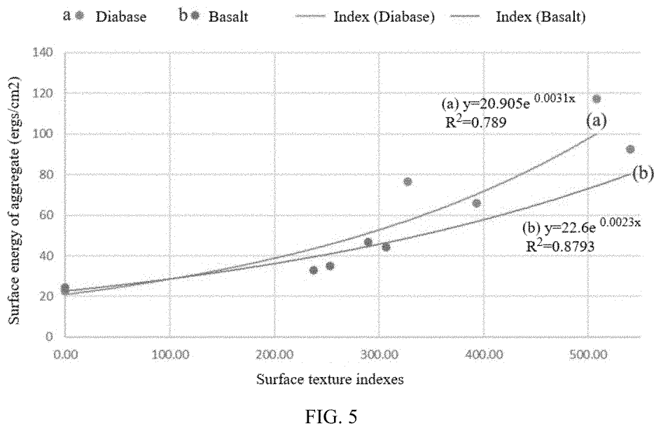

For each kind of aggregate, surface texture values of the polished aggregate and surface energy values of the polished aggregate are fitted with a model shown in the formula (5), and values of parameters A and K are calculated, so as to determine the function relationship formula of surface texture index and surface energy, and the fitting curve corresponding to the function relationship formula covers the surface texture index of the raw aggregate. Repeat this method to fit each kind of aggregate, and obtain the function relationship formula of surface texture index and surface energy of the two kinds of aggregates. The specific corresponding fitting curves are shown in FIG. 5. The fitting curves of diabase and basalt correspond to curves a and b in the FIG. 5 respectively.

The surface texture indexes of the raw aggregates of the two aggregates obtained above are respectively substituted into the corresponding function relationship formula, and the surface energy of the two aggregates considering the influence factors of surface texture is calculated. The two aggregates used in this embodiment are compared and tested by the traditional vapor adsorption method. The surface energies of the raw aggregates measured by the vapor adsorption method is compared with the surface energies of the raw aggregates measured by the disclosure, and the difference rates between the two are calculated. The comparison results are shown in Table 1.

TABLE 1
Comparison of surface energy test between the prediction calculation
method of the disclosure and the vapor adsorption method

| | Fitting Calculated | Tested Surface | |
|---|---|---|---|
| | Surface Energy/ | Energy/ | Difference |
| Aggregate type | (erg/cm²) | (erg/cm²) | rate/% |
| Diabase | 110.85 | 117.34 | 5.53 |
| Basalt | 88.24 | 92.45 | 4.55 |

It can be seen from the comparison results in the Table 1 that the surface energy results of the two aggregates obtained by the test method of the disclosure are very close to those obtained by the traditional vapor adsorption method, and the overall difference rate is less than 6%. It shows that the calculation results obtained by the above aggregate surface energy prediction method based on capillary rise method and sessile drop method have little difference from the test results of vapor adsorption method, which verifies the feasibility of this method. It further shows that the test method of the disclosure can replace the traditional vapor adsorption method. On the one hand, the method of the disclosure considers the two influencing factors of aggregate composition and surface texture, and can obtain more accurate test results. On the other hand, the low-cost sessile drop method is used to replace the high-cost vapor adsorption method, that is, the low-cost optical contact angle instrument and full-automatic surface tension instrument are used to replace the expensive magnetic levitation weight balance system (also referred to magnetic levitation control system) for aggregate surface energy test, which can significantly reduce the cost, so as to achieve the effect of obtaining high test accuracy with low test cost.

Compared with the related art, the disclosure provides a method for predicting and calculating surface energy of aggregate. In the process of calculating surface energy of aggregate, the influence of aggregate composition on surface energy and the influence of grinding treatment on aggregate surface texture are considered, and the actual surface texture conditions of aggregate are analyzed. The combination of sessile drop method and capillary rise method significantly improves the test accuracy, and can replace the vapor adsorption method to test the surface energy of aggregate, which greatly reduces the test cost and operation difficulty.

The above-described embodiments only illustrate implementation modes of the disclosure, and their descriptions are more specific and detailed, but cannot be understood as limiting the scope of disclosure patents. It should be noted that for those skilled in the art, several modifications and changes can be made without departing from the concept of the disclosure, which belong to the protection scope of the disclosure. Therefore, the scope of protection of the disclosure shall be subject to the appended claims.

What is claimed is:

1. A method for predicting and calculating aggregate surface energy, comprising:
step (1), raw aggregate screening and treatment, comprising: screening a raw aggregate and dividing the screened raw aggregate into a polished aggregate been sequentially surface polished and pretreated, an untreated raw aggregate, and a powdered aggregate been ground in form of powder;
step (2), surface texture index acquirement of the polished aggregate and the untreated raw aggregate, comprising: measuring surface textures of the untreated raw aggregate and the polished aggregate to obtain a surface texture index of the untreated raw aggregate and a surface texture index of the polished aggregate respectively;
step (3), powdered aggregate testing by a capillary rise method, comprising: testing the powdered aggregate by the capillary rise method to obtain surface energy of the powdered aggregate without influence of surface texture;
step (4), polished aggregate testing by a sessile drop method, comprising: testing a contact angle of the polished aggregate by the sessile drop method, and calculating surface energy of the polished aggregate;
step (5), function relationship formula fitting, comprising: fitting based on the surface texture index of the polished aggregate, the surface energy of the powdered aggregate and the surface energy of the polished aggregate to obtain a function relationship formula of surface texture index and surface energy; and
step (6), surface energy calculation of raw aggregate, comprising: substituting the surface texture index of the untreated raw aggregate into the function relationship formula of surface texture index and surface energy to thereby obtain surface energy of the raw aggregate considering influence of surface texture.

2. The method according to claim 1, wherein each of the untreated raw aggregate and the polished aggregate comprises aggregate samples with a particle size of 13.2˜16 millimeters (mm) after the screening;
wherein the polished aggregate has been surface polished by one or more selected from a group consisting of three surface polishing methods of cutting saw polishing, grinding wheel polishing and sandpaper polishing, a polishing time of each of the surface polishing methods is more than 30 seconds; and for each of the surface polishing methods, polishing degrees of the aggregate samples of the polished aggregate are the same.

3. The method according to claim 1, wherein a preparation of the powdered aggregate comprises:
weighing the screened raw aggregate with a particle size in a range of 2.36˜4.75 mm and then grinding the weighed raw aggregate, sieving the ground raw aggregate to obtain powders with particle sizes less than 0.075 mm to thereby obtain the powdered aggregate.

4. The method according to claim 2, wherein the measuring surface textures of the untreated raw aggregate and the polished aggregate to obtain a surface texture index of the untreated raw aggregate and a surface texture index of the polished aggregate respectively comprises:
fixing the aggregate samples of the untreated raw aggregate on an aggregate tray, collecting surface texture images of the aggregate samples of the untreated raw aggregate with an instrument of aggregate image measurement system (AIMS), and calculating the surface texture index of the untreated raw aggregate after averaging collection results; and
fixing the aggregate samples of the polished aggregate on the aggregate tray, collecting surface texture images of polished surfaces of the aggregate samples of each of the surface polishing methods with the instrument of AIMS, and calculating the surface texture index of the polished aggregate of each of the surface polishing methods after averaging collection results.

5. The method according to claim 4, wherein the testing the powdered aggregate by the capillary rise method comprises:
saturating and curing the powdered aggregate with toluene, and calculating effective radii of capillary synthesis through the capillary rise method with 2-pentanone, formamide and n-hexane as first test reagents;
testing by using a surface tension instrument under the first test reagents individually based on the capillary rise method, calculating a diffusion pressure under each of the first test reagents combined with the effective radius of capillary synthesis, and then calculating the surface energy of the powdered aggregate without the influence of surface texture according to Young-Dupre equation.

6. The method according to claim 5, wherein a calculation formula of the diffusion pressure is:
$${π}_{e ( M L )} = \frac{2 η}{{π}^{2} {R}_{e}^{5} {ρ}_{L}^{2}} \cdot \frac{{m}^{2}}{t} ;$$
where π_{e(ML)} represents the diffusion pressure, m represents a mass variation of the powdered aggregate, t represents time, ρL represents a density of the first test reagent, Rₑ represents the effective radius of capillary synthesis, and η represents a diffusion pressure coefficient.

7. The method according to claim 5, wherein the testing a contact angle of the polished aggregate by using the sessile drop method comprises:
starting an optical contact angle measuring instrument and preheating, placing the polished aggregate in a test chamber of the optical contact angle measuring instrument, and making the polishing surface of each of the aggregate samples of the polished aggregate be horizontal and face towards a camera of the optical contact angle measuring instrument;
adjusting reagent needles to preset positions, and releasing droplets of different second test reagents respectively;
moving the test chamber to make each of the aggregate samples correspondingly receive the released droplet; and
testing the contact angle between each of the aggregate samples and the received droplet within a preset test time.

8. The method according to claim 7, wherein the adjusting reagent needles to preset positions specifically comprises: pumping the different second test reagents into syringes respectively, moving positions of the reagent needles until a distance between each of the reagent needles and corresponding one of the aggregate samples is one droplet, and making the reagent needles and the aggregate samples appear in a capture image of the camera;
wherein the releasing droplets of different second test reagents respectively comprises: controlling pressures of the respective syringes to release the droplets with a same volume of the different second test reagents, and each of the released droplets is attached to a tip of each of the reagent needles; and
wherein the different second test reagents comprise distilled water, formamide and ethylene glycol, the different test reagents are pumped with three different syringes respectively, and each of the reagent needles releases the droplet of one of the different second test reagents correspondingly.

9. The method according to claim 7, wherein the calculating surface energy of the polished aggregate specifically comprises:
substituting the contact angle between the polished aggregate and each of the different second test reagents into the Young-Dupre equation, obtaining surface energy parameters by programming solution, and calculating the surface energy of the polished aggregate been treated by each of the surface polishing methods according to the surface energy parameters, wherein a calculation formula of the surface energy of the polished aggregate is:
2(\sqrt{γ_{S}^{LW}γ_{L}^{LW}}+\sqrt{γ_{S}⁺γ_{L}⁻}+\sqrt{γ_{S}⁻γ_{L}⁺})=γ_{L}(1+cos θ);
wherein the surface energy parameters comprise γ_{S}^{LW}, γ_{L}^{LW}, γ_{S}⁺, γ_{S}⁻, γ_{L}⁺, γ_{L}⁻ and γ_{L}, where γ_{S}^{LW} represents a non-polar component of surface energy of solid material, γ_{L}^{LW} represents a non-polar component of surface energy of liquid material, γ_{S}⁺ represents a polar acid component of the surface energy of solid material, γ_{S}⁻ represents a polar alkali component of the surface energy of solid material, γ_{L}⁺ represents a polar acid component of the surface energy of liquid material, γ_{L}⁻ represents a polar alkali component of the surface energy of liquid material, γ_{L} represents a liquid surface tension as a total surface energy, in unit of erg per square centimeter (erg/cm²), and θ represents the contact angle between three phases of solid, liquid and gas.

10. The method according to claim 9, wherein the fitting based on the surface texture index of the polished aggregate, the surface energy of the powdered aggregate and the surface energy of the polished aggregate to obtain a function relationship formula of surface texture index and surface energy comprises:
performing exponential fitting on the surface energy of the polished aggregate and the surface texture of the polished aggregate to obtain the function relationship formula of surface texture index and surface energy, and the function relationship formula is specifically as follows:
γ=Ae^{Kx};
where γ is an aggregate surface energy considering the influence of surface texture, in unit of erg/cm²; x is a surface texture index of aggregate; A is the surface energy of the powdered aggregate without the influence of surface texture, in unit of erg/cm²; K is a constant of determining an influence degree of surface texture on surface energy;
wherein in the exponential fitting, the parameters A and K are obtained, and the function relationship formula of surface texture index and surface energy is determined.
